(19) United States
(12) Patent Application Publication
(10) Pub. No.: US 2009/0012807 A1
(43) Pub. Date: Jan. 8, 2009

(54) System and Method for Generating Graphical Advertisements Based on Text Offers

(75) Inventors: Andrew Ian Atherton, San Francisco, CA (US); Lawrence Edward Morrisroe, San Jose, CA (US); Hongche Liu, Freemont, CA (US); Anthony D. Amidei, San Francisco, CA (US); Joshua Allen Rehling, San Francisco, CA (US); Matthew Carinio, San Luis Obispo, CA (US); Ryan Eric Christensen, San Farncisco, CA (US); Shubhasheesh Anand, Mountain View, CA (US); Kashyap N. Lodhiya, Sunnyvale, CA (US); Madhusudan Ramanna, Sunnyvale, CA (US); Julia Feldman, Studio City, CA (US); Barry Chu, Northridge, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/166,981

(22) Filed: Jul. 2, 2008

Related U.S. Application Data
(63) Continuation of application No. 11/476,324, filed on Jun. 28, 2006.

(51) Int. Cl. G06Q 10/00

(52) U.S. Cl. 705/1

(57) ABSTRACT

Systems and methods for generating a graphical advertisement based on a text offer are disclosed. Generally, an ad provider receives a request for a graphical ad. The ad provider sends a script to a browser comprising a call to a keyword extraction module. The ad provider receives a keyword from the keyword extraction module and determines a text offer associated with the keyword. The ad provider sends the text offer to the browser and sends an ad template for creating graphical advertisements based on the text offer to the browser.

### RELATED APPLICATIONS

The present application is a continuation of U.S. patent application Ser. No. 11/476,324 (still pending), filed Jun. 28, 2006, the entirety of which is hereby incorporated by reference.

### BACKGROUND

Online advertisement service providers such as Yahoo! Search Marketing typically provide many different types of advertisements. For example, an online advertisement service provider may provide graphical advertisements such as banner advertisements inserted into the body of a webpage. The online advertisement service provider may additionally provide text offers such as advertisements served to an Internet user in response to a search performed at a search engine.

Online advertisement service providers currently do not use graphical advertisements and text offers interchangeably. Therefore, when an online advertisement service provider receives a request for a graphical advertisement, if the online advertisement service provider is on pace to fulfill a delivery quota for the graphical advertisements relevant to the request, the online advertisement service provider does not serve an advertisement even though the online advertisement service provider has text offers relevant to the request.

### BRIEF DESCRIPTION OF THE DRAWINGS

FIG. 1 is a block diagram of one embodiment of a system for generating graphical advertisements based on text offers;

FIG. 2 is a diagram of one embodiment of an exemplary graphical advertisement based on a text offer;

FIG. 3 is a diagram of another embodiment of an exemplary graphical advertisement based on a text offer;

FIG. 4 is a diagram of another embodiment of an exemplary graphical advertisement based on a text offer; and

FIG. 5 is a flow chart of one embodiment of a method for generating a graphical advertisement based on a text offer.

### DETAILED DESCRIPTION OF THE DRAWINGS

The present disclosure is directed to systems and methods for automatically generating graphical advertisements based on text offers. Generating graphical advertisements based on text offers provides online advertisement service providers such as Yahoo! Search Marketing an efficient system and method to better take advantage of opportunities to serve graphical advertisements and to better monetize unsold graphical advertisement inventory.

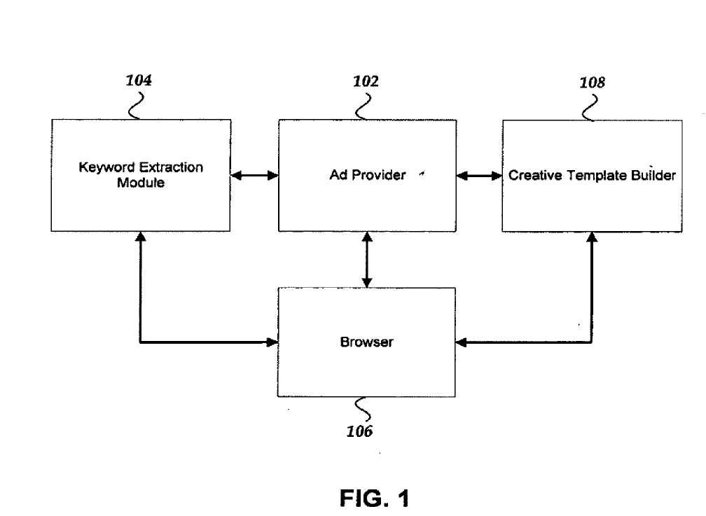

FIG. 1 is a block diagram of one embodiment of a system for generating graphical advertisements based on text offers. The system 100 includes an advertisement service provider 102 (“ad provider”), a keyword extraction module 104 in communication with the ad provider 102, and a creative template builder 108 in communication with the ad provider 102. The ad provider 102, keyword extraction module 104, and creative template builder 108 may be implemented as software code running in conjunction with a processor such as a single server, a plurality of servers, or any other type of computing device known in the art. Typically, the system 100 is connected over an internal or external network to one or more web servers hosing search engines and/or webpages. In response to actions such as a search at a search engine or a request by a user to view a webpage, a web server sends a request over a network to the ad provider for an ad including various types of ad parameters. After receiving the ad request, the ad provider determines a relevant ad based on the ad parameters of the ad request and sends data including an ad over the network to the web server requesting the ad.

With systems that generate a graphical ad based on a text offer, the ad provider 102 first receives a request for a graphical ad such as a banner ad. The ad provider 102 determines a plurality of ads eligible to be served in response to the request and determines whether each of the ads of a guaranteed class of ads is on pace to fulfill a delivery quota. If each ad of the guaranteed class is on pace to fulfill their respective delivery quotas, the ad provider 102 determines a type of ad of a non-guaranteed class with a highest priority.

If the type of ad with the highest priority is a text offer, the ad provider 102 creates a script and sends the script to a browser 106 that will construct the webpage. In constructing the webpage, the browser 106 executes the script, causing the browser 106 to call the keyword extraction module 104. The keyword extraction module 106 examines the content of the webpage and/or examines data stored at the browser 106 to determine a keyword.

The keyword extraction module 104 sends the determined keyword to the ad provider 102. Based on the determined keyword and various performance parameters stored at the ad provider 102, the ad provider 102 determines a text offer with a highest priority and sends the text offer to the browser 106. The keyword extraction module 104 may additionally send the determined keyword to the browser 106. In implementations where the keyword extraction module 104 sends the keyword to the browser 106, the browser may display the keyword in an advertisement as explained in more detail below.

The browser 106, executing the received script, requests an ad template from a creative template builder 108 of the ad provider 102. The creative template builder 108 sends the ad template, including formatting instructions for a graphical ad as set by an advertiser, to the browser 106. The browser 106, using the received ad template, the received text offer, and possibly a received keyword, constructs a graphical ad on the webpage based on the text offer.

As discussed above, the ad provider 102 receives a request for a graphical ad, such as a banner ad. In one embodiment, the request for the graphical ad includes information such as a characteristic of a webpage where the graphical ad will be rendered and/or an attribute of a user who will view the webpage.

The ad provider 102 determines a plurality of ads that are eligible to serve in response to the graphical ad request. The ad provider 102 then examines the class of the ads eligible to serve in response to the graphical ad request. Typically, the ad provider 102 serves at least two classes of ads. In one implementation, the ad provider serves a guaranteed class of ads and a non-guaranteed class of ads, but an ad provider 102 may define classes of ads in any way. For the guaranteed class of ads, the ad provider 102 agrees to serve a defined number of ads for an advertiser over a defined period of time. For a non-guaranteed class of ads, an advertiser has agreed to compensate the ad provider 102 each time the ad provider 102 chooses to serve an ad. The non-guaranteed class of ads may include both graphical ads and text offers. It will be appreciated that the ad provider 102 typically gives preference to ads of a guaranteed class over ads of a non-guaranteed class.

The ad provider 102 determines whether the ad provider 102 is on pace to fulfill a delivery quota associated with each ad of the guaranteed class that is eligible to serve in response to the graphical ad request. A delivery quota is a number of ads that the ad provider 102 has agreed to serve within a period of time, in one example. Other quota definitions or arrangements may be applied as well. One method for determining whether the ad provider 102 is on pace to fulfill a delivery quota associated with an ad is disclosed in U.S. Pat. application Ser. No. 11/253,907, filed Oct. 19, 2005, the entirety of which is hereby incorporated herein by reference.

If the ad provider 102 is not on pace to fulfill a delivery quota associated with an ad of the guaranteed class eligible to serve in response to the graphical ad request, the ad provider 102 may serve an ad of the guaranteed class. However, if the ad provider 102 is on pace to fulfill a delivery quota associated with each ad of the guaranteed class eligible to serve in response to the graphical ad request, the ad provider 102 may serve an ad of the non-guaranteed class. The ad provider 102 examines the ads of the non-guaranteed class eligible to serve in response to the graphical ad request to determine an ad type with the highest priority. In one embodiment, the ad provider 102 determines an ad type with the highest priority by determining the ad type that will result in the highest compensation for the ad provider 102. For example, the ad provider 102 may compare a cost per thousand impressions (“CPM”) for one or more graphical ads of the non-guaranteed class with an estimated cost per thousand impressions (“eCPM”) of one or more text offers of the non-guaranteed class. The ad provider 102 calculates an eCPM of a text offer by multiplying a cost per click (“CPC”) associated with the text offer by the quantity of a click through rate (“CTR”) associated with the text offer divided by 1000.

If the ad provider 102 determines a graphical ad of the non-guaranteed class has a highest priority, the ad provider 102 may serve a graphical ad in response to the graphical ad request. However, if the ad provider 102 determines a text offer has a highest priority, the ad provider 102 creates a script that is served in response to the graphical ad request. In one embodiment, the script is a JavaScript, but any type of script known in the art could be used. The ad provider 102 creates a script, that when executed by the browser 106 constructing the webpage, causes the browser 106 to call the keyword extraction module 104.

In response to the call, the keyword extraction module 104 determines a keyword related to the graphical ad request. The keyword may be a single word or a phrase. One example of a keyword extraction module 104 is described in U.S. patent application Ser. No. 10/829,814, filed Apr. 21, 2004, the entirety of which is hereby incorporated by reference. In one embodiment, the keyword extraction module 104 determines a contextually relevant keyword based on the content of the webpage where the graphical ad will be rendered. The keyword extraction module 104 may additionally determine a behaviorally relevant keyword based on data saved at a browser such as a browser cookie that indicates the behavior of a user interacting with the client browser.

The keyword extraction module 104 sends the determined keyword to the ad provider 102 and may send the determined keyword to the browser 106. The ad provider 102 determines a plurality of text offers related to the keyword as is known in the art and determines a text offer with the highest priority. In one embodiment, to determine a text offer with the highest priority, the ad provider 102 accesses one or more performance parameters associated with the text offers. The ad provider 102 calculates the eCPM for one or more text offers as described above. The ad provider 102 may choose a text offer related to the determined keyword with the highest eCPM, but it will be appreciated that the ad provider 102 may choose a text offer based on any performance parameter or any number of performance parameters. After determining the text offer with the highest priority, the ad provider 102 sends the text offer to the browser 106 and may record various performance parameters associated with the text offer.

Before or after receiving the text offer, the browser 106, executing the received script, requests an ad template from the creative template builder 108 of the ad provider 102. The ad server 102 sends the ad template, which includes formatting instructions based on the selected text offer, to the browser 106. The formatting instructions may be graphical ad format settings set by an advertiser, a campaign optimizer of an ad campaign management system, or any other portion of an ad campaign management system such as those described in U.S. patent application Ser. No. 11/324,129, filed Dec. 30, 2005, the entirety of which is hereby incorporated herein by reference. Examples of formatting instructions include a size limit of a graphical ad, one or more colors that should be included in a graphical ad, one or more colors that should be avoided in a graphical ad, one or more images that should be included in a graphical ad, one or more types of images that should not be included in a graphical ad, or any other type of information associated with a configurable element of a graphical ad related to a text offer.

Based on the received text offer, the received ad template, and possibly a received keyword, the browser 106 generates a graphical ad and renders the graphical ad on the constructed webpage. In one implementation, an ad template may be JavaScript or a Flash template, but any type of code known in the art could be used.

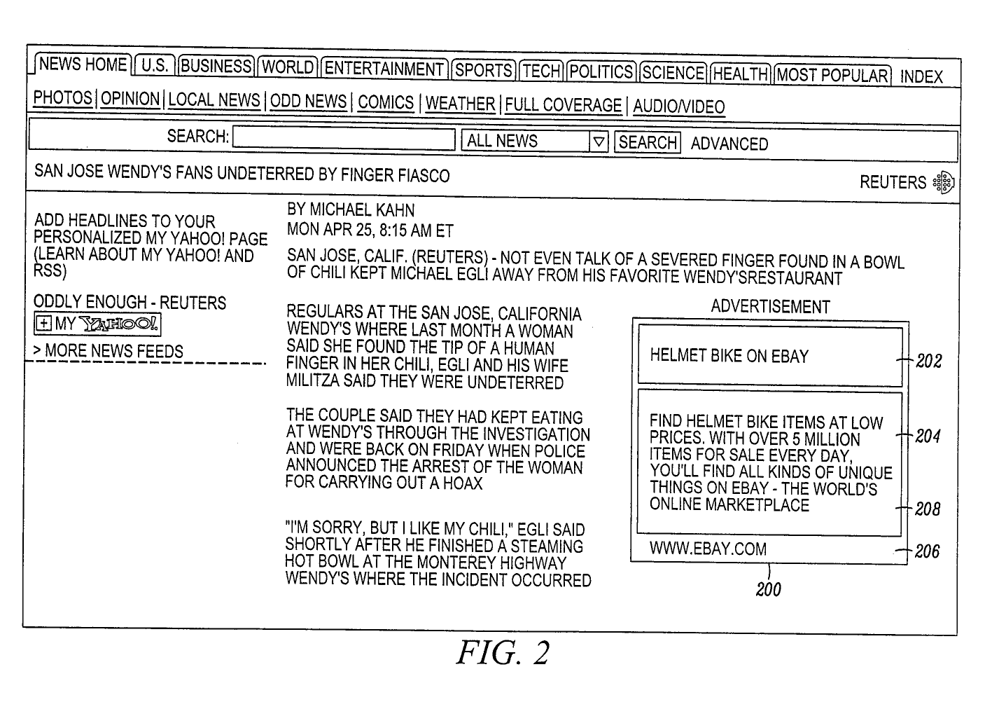

FIGS. 2-4 are exemplary embodiments of graphical ads 200, 300, 400 based on text offers. In FIG. 2, a graphical ad 200 including a title 202, short description 204, and URL 206 from a text offer is rendered on a typical webpage. In the graphical ad 200 of FIG. 2, the title 202, short description 204, and URL 206 are rendered on a solid colored background 208, but in other embodiments the title 202, short description 204, and URL 206 may be rendered on any type of patterned background or image.

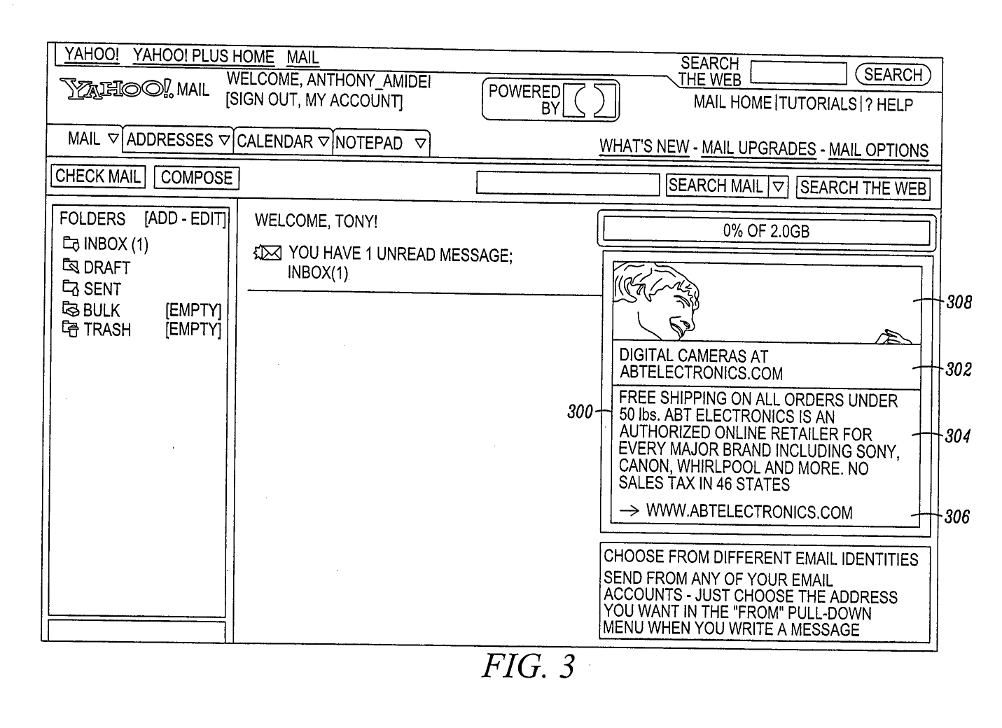

In FIG. 3, a graphical ad 300 including a title 302, short description 204, and URL 306 from a text offer is rendered on a webpage for a web-based email account. In the graphical ad 300 of FIG. 3, the title 302, short description 304, and URL 306 are rendered on an image 308, but in other embodiments the title 302, short description 304, and URL 306 may be rendered on a solid colored background, or a background with any other type of pattern.

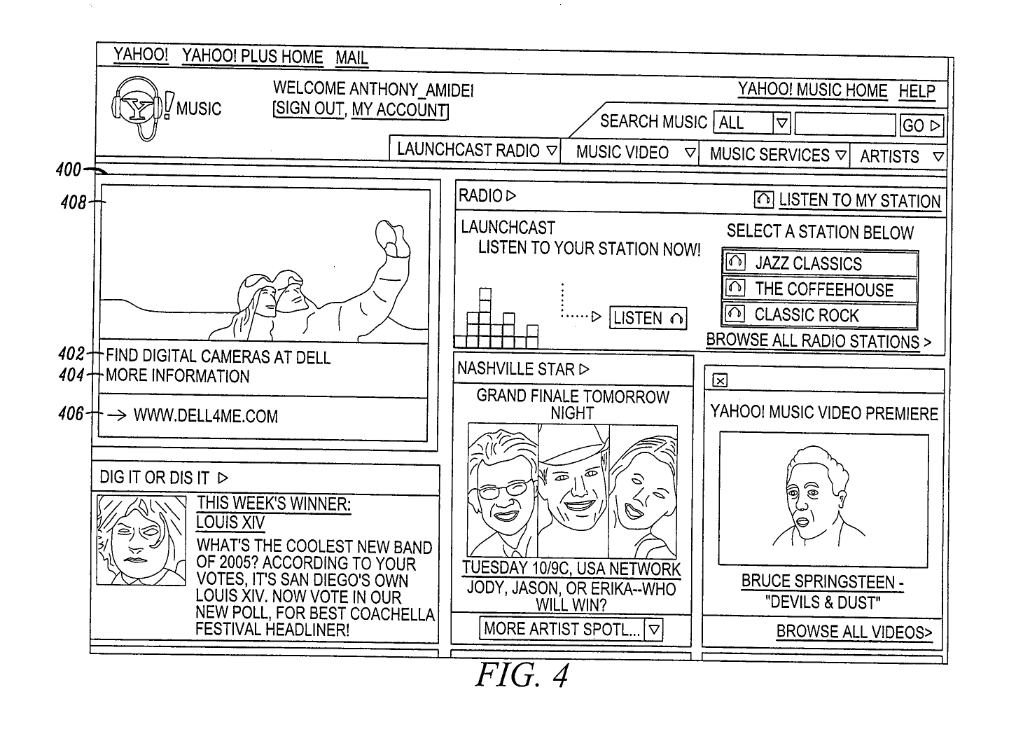

In FIG. 4, a graphical ad 400 including a title 402, short description 404, and URL 406 from a text offer is rendered on a typical webpage. In the graphical ad 400 of FIG. 4, the title 402, short description 404, and URL 406 are rendered on an image 408, but in other embodiments the title 402, short description 404, and URL 406 may be rendered on a solid colored background, or a background with any other type of pattern.

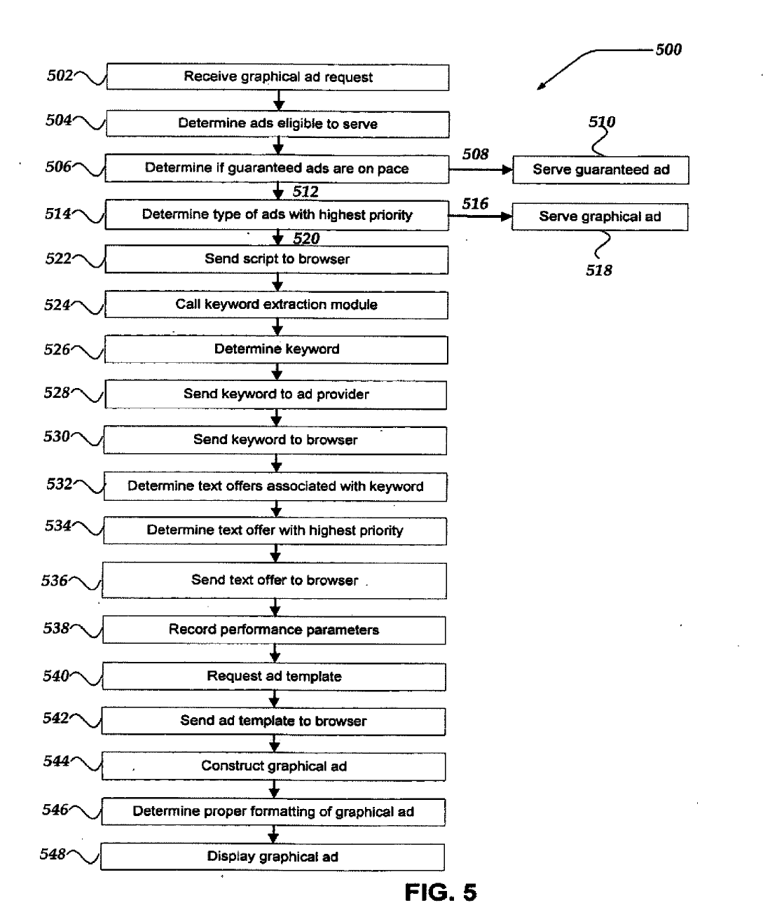

FIG. 5 is a diagram of one embodiment of a method for generating a graphical ad based on a text offer. The method 500 begins with an ad provider receiving a request for a graphical ad at block 502. The ad provider determines a plurality of ads that are eligible to be served in response to the graphical ad request at block 504.

The ad provider determines whether each ad of a guaranteed class is on pace to fulfill their respective delivery quota at block 506. If one or more ads of the guaranteed class are not on pace to fulfill their respective delivery quota 508, the ad provider serves an ad of the guaranteed class at block 510 and the method 500 ends. However, if the ad provider determines each ad of the guaranteed class is on pace to fulfill their respective delivery quota 512, the ad provider determines which type of ad of the non-guaranteed class has the highest priority at block 514. As explained above, the ad provider may determine which type of ad has the highest priority by comparing the CPM of one or more graphical ads with the eCPM of one or more text offers.

If the ad provider determines that a graphical ad of the non-guaranteed class has the highest priority 516, the ad provider serves a graphical ad of the non-guaranteed class at block 518 and the method 500 ends. However, if the ad provider determines a text offer has the highest priority 520, the ad provider creates a script and sends the script to a browser at block 522.

The browser executes the script and calls the keyword extraction module at block 524. The keyword extraction module determines a keyword at block 526 based on the content of a webpage where the graphical ad will be inserted and/or based on data stored at the browser such as a browser cookie indicating the behavior of a user interacting with the browser. The keyword extraction module sends the keyword to the ad provider at block 528 and may send the keyword to the browser at block 530.

The ad provider determines a plurality of text offers associated with the keyword at block 532. The ad provider then determines a text offer of the plurality of text offers having the highest priority at block 534. As explained above, the ad provider may determine a text offer having the highest priority based on the eCPM of one or more text offers. The ad provider sends the determined text offer to the browser at block 536 and may record various performance parameters associated with the determined text offer at block 538.

Before or after receiving the determined text offer, the browser requests an ad template from a creative template builder of the ad provider at block 540. The ad provider sends the ad template, including formatting instructions for the determined text offer as described above, to the browser at block 542. Based on the received text offer and ad template, the browser constructs a graphical ad based on the text offer at block 544. In some embodiments, constructing the graphical ad my include determining a proper size, color scheme, or image for the graphical ad. The browser then renders the graphical ad on the webpage at block 546. The browser may then display the generated graphical ad based on the text offer on a webpage at block 548.

FIGS. 1 and 5 illustrate systems and methods for generating a graphical ad based on a text offer. The efficient systems and methods provide online ad service providers the ability to better take advantage of opportunities to serve graphical advertisements and to better monetize unsold graphical advertisement inventory so that an online ad service provider may increate compensation while fulfilling agreements to serve a number of ads over a predefined period of time to some advertisers.

It will be appreciated that the systems and methods of FIGS. 1 and 5 may be modified and still fall within the spirit and scope of the present invention. For example, while the implementations above describe a client browser requesting and receiving a text offer and an ad template separately, in other implementations, the ad template may request and receive the text offer. Additionally, while the implementations above describe an ad provider serving a text offer from a single database where advertisers have bid on keywords, in other implementations, the keywords may be product categories and the ad provider may search two or more different databases with text offers associated with different products and services for sale to determine a text offer with a highest priority based on factors such as eCPM. For example, the ad provider may search databases that include text offers such as product offers taken from e-commerce retailers, travel packages from retailers such as online travel agencies, or any other type of textual offer available on the Internet where a product or service is being offered for sale. It is therefore intended that the foregoing detailed description be regarded as illustrative rather than limiting, and that it be understood that it is the following claims, including all equivalents, that are intended to define the spirit and scope of this invention.

1. A method for generating a graphical advertisement based on a text offer comprising:
sending a script to a browser, the script comprising a call to a keyword extraction module;
determining a text offer associated with a keyword from the keyword extraction module;
sending the text offer to a browser; and
sending an ad template to the browser for creating a graphical advertisement based on the text offer.

2. The method of claim 1, wherein the keyword extraction module determines the keyword based on the content of the webpage.

3. The method of claim 1, wherein the keyword extraction module determines the keyword based on a browser cookie stored at the browser.

4. The method of claim 1, further comprising:
receiving a request for a graphical advertisement;
determining a plurality of advertisements eligible to serve in response to the request for a graphical advertisement;
determining whether each advertisement of a first class of advertisements of the plurality of eligible advertisements is on pace to fulfill a delivery quota; and
determining a type of advertisement of a second class of advertisements of the plurality of eligible advertisements with a highest priority.

5. The method of claim 4, wherein the first class of advertisements is a guaranteed class of advertisements and the second class of advertisements is a non-guaranteed class of advertisements.

6. The method of claim 4, wherein determining a type of advertisement of a second class of advertisements with a highest priority comprises:
determining cost per thousand impressions (“CPM”) for one or more advertisements of the second class of advertisements;
determining estimated cost per thousand impressions (“eCPM”) for one or more text offers of the second class of advertisements; and
comparing the determined CPMs with the determined eCPMs.

7. The method of claim 1, wherein the script is a java script.

8. The method of claim 1, wherein the ad template is a flash template.

9. The method of claim 1, wherein the graphical advertisement is a banner advertisement.

10. The method of claim 1, wherein the ad template comprises at least one formatting instruction for a graphical advertisement based on the determined text offer.

11. The method of claim 10, wherein the at least one formatting instruction is at least one of a color scheme to be included in the graphical advertisement based on the determined text offer, an image to be included in the graphical advertisement based on the determined text offer, and a size of the graphical advertisement based on the determined text offer.

12. The method of claim 1, further comprising:
storing at least one performance parameter associated with the determined text offer.

13. A system for generating a graphical advertisement based on a text offer comprising:
an advertisement provider operative to send a script to a browser in response to the request for the graphical advertisement; and
a keyword extraction module in communication with the advertisement provider, the keyword extraction module operative to receive a call from a browser, to determine a keyword based on at least one of webpage content and data stored at the browser, and to send the determined keyword to the advertisement provider and the browser;
wherein the advertisement provider is further operative to determine a text offer associated with the determined keyword and to send the text offer and an ad template for creating a graphical advertisement based on the text offer to the browser.

14. The system of claim 13, wherein the graphical advertisement is a banner advertisement, the script is a java script, and the ad template is a flash template.

15. The system of claim 13, wherein the advertisement provider is further operative to:
receive a request for a graphical advertisement;
determine a plurality of advertisements eligible to serve in response to the request for a graphical advertisement;
determine whether each advertisement of a first class of advertisements of the plurality of eligible advertisements is on pace to fulfill a delivery quota; and
determine a type of advertisement of a second class of advertisements of the plurality of eligible advertisements with a highest priority.

16. The system of claim 15, wherein the first class of advertisements is a guaranteed class of advertisements and the second class of advertisements is a non-guaranteed class of advertisements.

17. The system of claim 15, wherein the advertisement provider determines the type of advertisement of the second class of advertisements of the plurality of eligible advertisements with a highest priority based on the cost per thousand (“CPM”) of one or more graphical advertisements and the estimated cost per thousand (“eCPM”) of one or more text offers.

18. The system of claim 13, wherein the ad template comprises at least one formatting instruction for a graphical advertisement based on the determined text offer.

19. A computer-readable storage medium comprising a set of instructions to direct a computer system to perform acts of:
sending a script to a browser, the script comprising a call to a keyword extraction module;
determining a text offer associated with a keyword from the keyword extraction module;
sending the text offer to a browser; and
sending an ad template to the browser for creating a graphical advertisement based on the text offer.

20. The computer-readable storage medium of claim 19, further comprising a set of instructions to direct the computer system to perform acts of:
receiving a request for a graphical advertisement
determining a plurality of advertisements eligible to serve in response to the request for a graphical advertisement;
determining whether each advertisement of a first class of advertisements of the plurality of eligible advertisements is on pace to fulfill a delivery quota; and
determining a type of advertisement of a second class of advertisements of the plurality of eligible advertisements with a highest priority.

21. The computer-readable storage medium of claim 10, wherein determining a type of advertisement of a second class of advertisements with a highest priority comprises
determining cost per thousand impressions (“CPM”) for one or more advertisements of the second class of advertisements;
determining estimated cost per thousand impressions (“eCPM”) for one or more text offers of the second class of advertisements; and
comparing the determined CPMs with the determined eCPMs.
